(19) United States
(12) Patent Application Publication
(10) Pub. No.: US 2002/0091596 A1
(43) Pub. Date: Jul. 11, 2002

(54) Process and system for the customisation of consumer products

(76) Inventors: David Robert Dudek, Katy, TX (US); John Melvyn Lloyd Jones, Farmham Surrey (GB); David Campbell Murray, Dublin (IE); Peter Sandiford, Markyate (GB)

Correspondence Address: Yukiko Iwata, Shell Oil Company, Legal - Intellectual Property, P. O. Box 2463, Houston, TX, 77252-2463, US

(21) Appl. No.: 09/843,381

(22) Filed: Apr. 25, 2001

(30) Foreign Application Priority Data
Apr. 25, 2000 (EP) 00303425.3

(51) Int. Cl. G06F 17/00; G06F 17/60

(52) U.S. Cl. 705/29; 700/233

(57) ABSTRACT

A process is provided for the customization of consumer products, wherein said consumer products are prepared according to selections of product characteristics and made by a consumer, optionally reconstituted with one or more other components, and dispensed from a vending system at the point-of-sale of said consumer products. A vending system is also provided for the customization of consumer products, wherein said consumer products are prepared according to selections of product characteristics and made by a consumer, optionally reconstituted with one or more other components and dispensed from said vending system at the point-of-sale of said consumer products.

This application claims priority to the foreign application filed on Apr. 25, 2000, in Europe and having a serial number of 00303425.3.

### FIELD OF THE INVENTION

The present invention relates to a process and system for the customisation of consumer products, particularly cleaning products.

### BACKGROUND OF THE INVENTION

Currently, cleaning product manufacturers fill finished cleaning products into small disposable containers, which are typically 250 ml to 5 liters in volume, at the manufacturing site.

The cleaning product manufacturer then distributes the finished cleaning products in such containers to individual retail outlets. Such distribution of said products may be direct distribution to the retail outlets, or through, for example, a regional distribution centre of the retailer.

No change in the product can occur after the finished cleaning product leaves the cleaning product manufacturer. The number of product variants for a particular product line may be large. For example, in the area of liquid fabric softeners, a cleaning product manufacturer may have 5 or 6 different fragrances (each with a separate identifying colour), 3 or 4 different pack sizes, and offer product in both ready-to-use and concentrate form. This can mean upwards of 40 different product variants being stocked at one particular retail site for just one product line.

Such a method is inefficient in terms of space utilisation, and reduces the retailer's return per square meter of retail floor space.

There are, in addition, a number of further additives that may be added to cleaning products. Such additives may include, for example, anti-bacterial agents, bleaching agents and agents to prevent creasing of fabrics. However, for economic reasons, such additives are usually only offered in a small number of cleaning product variants.

It is highly desirable to utilise retail floor space more efficiently, whilst maintaining the widest possible product choice for the consumer.

Where the precise formulation of a product is to be determined by the consumer or user, it is typical to allow the consumer or user to select from ingredients and determine the mix of ingredients according to need or personal preference.

For example, products for cosmetic use can be tailored for specific skin types, paint colour can be determined by use of an example or sample of fabric and the product is then mixed to meet those specific requirements.

Typically, such a method employs a means of mixing that can be controlled directly or indirectly by the user and a means of dispensing the resulting product.

Normally, the means of mixing involves some specialist know-how or an operator who is briefed on the function of the mixing method.

Where this is not the case, the degree of flexibility is typically limited to a selection of predetermined mixes or combinations and is not infinitely flexible.

Filling machines may dispense a wide variety of products from the same machine. Such machines may include production line filling machines and vending systems which are designed to fill containers at sites located in, for example, retail outlets, offices and other workplaces.

By “vending system” in the present invention is meant a filling machine that dispenses product in response to one or more selections that are input into the machine by the consumer or user. Such a system may be operated by coin, token, card, or other suitable means.

Vending systems are known in the art for dispensing beverages such as tea and coffee according to the precise selection made by the user. Such beverages may also be made by the user according to traditional methods. However, in many situations, where time is short, or facilities are limited, the use of vending system for dispensing of beverages offers a convenient alternative. However, it will be appreciated that such a system merely serves to automate a process that the user may otherwise perform themselves.

Unlike the production of beverages such as tea and coffee, the formulation of cleaning products adds complexity to product manufacture, which means such processes cannot be replicated by the unskilled user in normal use locations. That is to say, the science of cleaning product formulation is a very precise art, which requires carefully controlled ratios of raw materials in order to produce a fully optimised finalised cleaning product.

It is not currently possible in the art to “deskill” the process of finalised cleaning product manufacture to the point where the unskilled user may employ a method of customisation of their own accord without having to significantly reduce the scope of choice and the number of product variants possible.

There has now been found a process for providing the consumer complete freedom of choice with respect to finalised cleaning product formulation, with a substantial likelihood of a well-reconstituted product, whilst also offering an improved utilisation of space on the retail floor to the retailer, and thereby increasing the retailer's return per square meter of floor space.

### SUMMARY OF THE INVENTION

According to the present invention there is provided a process for the customisation of consumer products, wherein said consumer products are prepared according to selections of product characteristics made by a consumer, optionally reconstituted with one or more other components and dispensed from a vending system at the pointof-sale of said consumer products.

In a further aspect, the present invention provides a dispensing system, such as a vending system, for the customisation of consumer products, wherein said consumer products are prepared according to selections of product characteristics made by a consumer, optionally reconstituted with one or more other components and dispensed from said vending system at the point-of-sale of said consumer products.

By “consumer products” in the present invention is meant products which are produced by processes that cannot be reliably and/or easily replicated by an unskilled user in normal use locations. For example, the manufacture of cleaning products, as performed by cleaning products manufacturers cannot be easily replicated by the consumer in the home. Similarly, whilst it is possible for the consumer to mix paint products in the home, said products cannot be reliably replicated on successive occasions without the consumer having to expend considerable time, care and attention.

Such consumer products include in particular cleaning products.

The vending system of the present invention serves to allow concentrates with different physical characteristics, such as solids and liquids, to be mixed and optionally reconstituted together.

It will be appreciated that reconstitution is an optional step in the customisation of consumer products, and is dependent upon the requirements of the consumer. For example, for ease of transport, the consumer may wish to leave the customised consumer product in concentrated form until said product is in the use environment, for example in the consumer's home, whereupon said product may be reconstituted by the consumer or user. However, in order to ensure that the reconstituted product is of uniform quality without any permutation in the degree of reconstitution of constituents, in a preferred embodiment of the present invention said consumer products will be reconstituted prior to being dispensed from the vending system.

The time taken to make a selection of consumer product concentrate combinations by the consumer implies greater time will be taken at the dispensing location. In the case of said dispensing location being a vending system at a location experiencing high traffic throughput, the time taken may inhibit use, or may prevent additional users from accessing the vending system.

Consequently, according to a preferred embodiment of the present invention, there is provided a vending system and a process for the simultaneous multiple customisation of consumer products, wherein said consumer products are prepared according to selections of product characteristics made by one or more consumers, optional reconstitution with one or more other components and dispensing of consumer products.

Such an arrangement is particularly useful and allows queues to be minimised during peak traffic periods by providing multiple dispense points, each point being capable of producing any mix of concentrate or reconstituted product, and in any volume, according to user choice, simultaneously.

By “point-of-sale” in the present invention is meant anywhere where the vending system is located. It is most likely that the point-of-sale will be in a retail environment or a kiosk. However, such a vending system may be located in a stand-alone location, a laundry, industrial or otherwise, or in any location wherein there is a large demand for said consumer products, for example a hotel, housing complex or hospital.

By “concentrate” in the present invention is meant a generic concentrate which contains only the basic formulation components in concentrated form. Said concentrate will be typically unscented and may be further customised by the addition of one or more additives so as to provide further features and properties to the subsequently reconstituted product. Said additive sources may be of disparate types, for example, liquids and solids. Said concentrate will be typically delivered in bulk to the vending system. It will be appreciated that said additives may also be concentrated.

The combination of many product variants into the delivery of a single generic concentrate, for subsequent customisation, simplifies the supply chain, increases supply chain responsiveness and lowers the total supply chain inventory.

In the present invention, consumer product concentrate sources are dosed according to the consumer's or user's instructions and final requirements. Said instructions are conveniently made by means of an interface located on the vending system. Said interface may be of any kind commonly used in the art. Preferably, said interface will be a touch-sensitive screen.

Concentrate and/or diluent sources will be housed in bulk reservoirs inside the vending system, or fed into the vending system from an external location through conduits.

In the case of said vending system comprising multiple dispense points, said dispense points may be conveniently linked in parallel to the same concentrate and/or diluent sources.

Once the desired concentrate sources have been dosed to achieve the desired chemical properties and/or physical properties of the consumer product, the customised concentrated consumer product may be dispensed, or, in a preferred embodiment, one or more diluents may be added to reconstitute the consumer product to achieve its desired concentration.

Thus, reconstitution with diluent offers the consumer the choice of purchasing the product in more traditional ready-to-use forms or in a more concentrated form. As well as ease of transport, such an option allows the consumer to customise strength of the consumer product according to requirements. In the case of cleaning products this could depend upon the demands of the articles to be cleaned.

Said reconstituted product may then be dispensed into a storage container.

The nature of the storage container that may be employed in the present invention is not limited and it is possible to dispense the optionally reconstituted product into a standard external storage container of any kind known in the art.

Standard storage containers are available in a wide variety of shapes and forms. They may be assembled from a wide variety of components, and may be manufactured from a wide variety of materials.

Said containers may be manufactured from a plastics material. As such, said container may be manufactured by any conventional forming process, such as for example an extrusion or an injection blow-moulding process.

The storage container may be an open vessel. However, in a preferred embodiment of the present invention, the storage container will be a closed vessel, for example having a bottom portion, side walls and an upper portion.

The terms “bottom”, “side” and “upper” are used to identify the positions of those portions of the container when it is in its normal orientation in use.

Said storage container may comprise any number, combination and orientation of fill and/or dispense apertures that meet the needs of the product, its intended use or its method of use. Said fill and/or dispense apertures will be preferably housed in the upper portion of said storage container.

The fill aperture may be designed to be opened manually by the user, or automatically when in connection with a filling head of the vending system.

The containers for use with the present invention may include any dispensing, dosing or application feature or device providing the means to dispense the product in a wide variety of ways.

The design of such containers may include provision for manual or powered dispensing.

The container may include any further device or mechanism for filling known in the art.

In a preferred embodiment of the present invention, said storage container will be reusable, thereby allowing the consumer to use the container for multiple customisation-fill-use cycles.

Consumer-led filling of cleaning product into storage containers and the re-use of said storage containers allows further reductions in packaging, filling and distribution costs.

In a further preferred embodiment of the present invention, the process may include a remote means of operating the vending system so that the point of selection can be positioned at a location separate from the point of dispense.

The means of communication between the user and the machine may be by direct electronic link or by modem, whereby the user selects and customises the product selection on a touch screen or at a computer terminal and the selection is communicated to the dispense point, to be dispensed at that time or at a time to be set by the consumer, or at a signal given to the dispense point by the consumer by means of a card or a code or some such device at the time the consumer wishes to collect the product.

This arrangement allows for the consumer to select and customise the product at a time and in a location that suits the consumer, for example, from home prior to a visit to the point of dispense at a location that may be in a high street, in a shopping mall, or located in or near to a car park or means of mass transportation such as a train station.

This arrangement also allows for greater throughput to be achieved by enabling the vending system to be connected to a plurality of interfaces and/or one or more further vending systems, such that any interface may be used to select and customise product according to availability of an interface and any dispense point may be used to dispense product according to loading, such that the wait time for any transaction is always minimal.

This arrangement also allows the vending system to batch process consumer product orders that are similar or identical in order to promote efficient dispensing.

This arrangement also allows a collection of vending systems to parallel process a single large consumer product order, such that the consumer or user wait time is reduced.

The vending system and process of the present invention may be conveniently used for a wide variety of materials such as foodstuffs, beverages, household products such as detergents and automotive products such as lubricants.

### BRIEF DESCRIPTION OF THE DRAWING

The present invention will now be described by way of example with reference to the accompanying drawings. It is to be noted, however, that the accompanying drawings illustrate only some embodiments of the invention and are therefore not to be considered limiting of its scope, because the invention may admit to other equally effective embodiments.

FIG. 1 is a functional block diagram of the process of the present invention.

FIG. 2 is a schematic view of a system using the process described in FIG. 1.

### DETAILED DESCRIPTION OF THE INVENTION

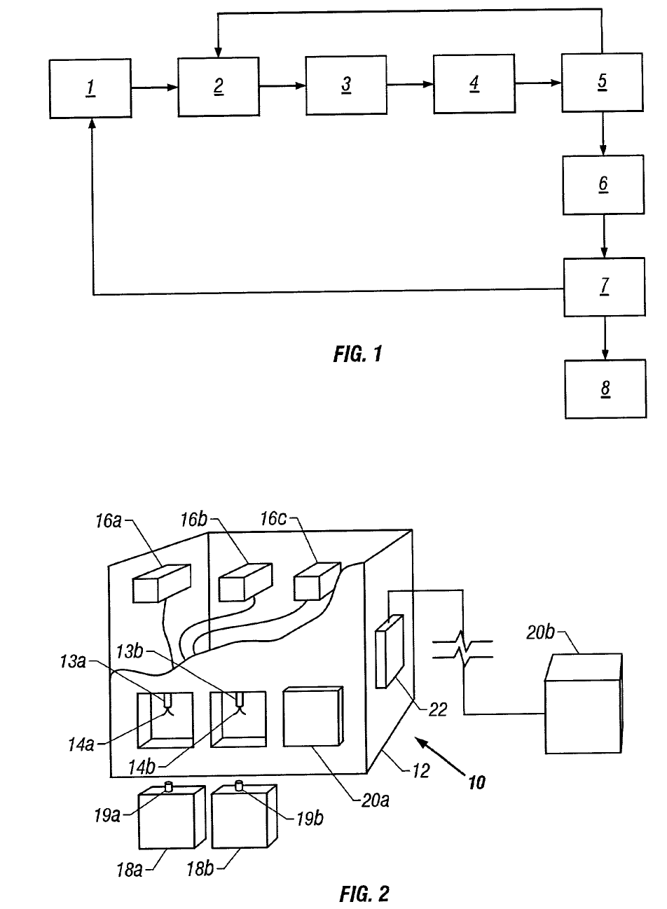

Referring to FIG. 1, the consumer decides to purchase, for example, cleaning product and places in step 1 a storage container in a dispense point of a vending system.

Said consumer selects in step 2 the type of product to be dispensed from available options that are shown on an interface of the vending system. Said choices may include, for example, liquid fabric softener, liquid fabric detergent, washing-up liquid and general household detergent. It will be appreciated that depending upon the nature of the cleaning products and their compatibility, it may be possible to select multiple product types for a single cleaning product dispense. For example, said cleaning product may be a combined liquid fabric detergent and softener.

Said consumer then customises in step 3 the cleaning product's characteristics from the available options that are shown on the interface of the vending system for that particular product type. Said options may include, for example, fragrance, colour, antibacterial agents, bleaching agents, agents to prevent the creasing of fabrics, water softeners and limescale removers.

Said consumer then selects in step 4 the amount of cleaning product required from the available options that are shown on the interface of the vending system, and whether the cleaning product is to be reconstituted or dispensed as a concentrate.

Said consumer then checks and confirms in step 5 that the cleaning product specification shown on the interface of the vending system is correct, prior to dispensing in step 6 said cleaning product from the vending system.

If the cleaning product specification is incorrect, the customer may indicate this on the interface of the vending system and may re-start the process of step 2.

Following dispensing of the cleaning product, and removal of the storage container from the dispense point of the vending system, the consumer is given the choice in step 7 of repeating the process of step 1 in order to dispense further cleaning products according to their individual requirements.

If the consumer does not require any further cleaning products, the process ends at step 8.

FIG. 2 is a schematic view of a system using the process described in FIG. 1. The system described in FIG. 2 is merely exemplary of one system that can be used with that process and is not restricted to the number of elements shown, individual arrangements of the elements, relative size, or shape. The system shown is merely exemplary of one embodiment and can be arranged in different ways, added to, and subtracted therefrom.

A dispensing system 10 can include one or more filling machines 12. In some embodiments, the filling machine may be a vending machine or vending system. The dispensing system may be located in commercial or retail establishments, at point of use, in manufacturing facilities, and in other places where the customisation of consumer products may be performed. The dispensing system 10 can include one or more dispensing points 13a, 13b. The dispensing points can be used to dispense product 14a, 14b discharged from the dispensing points. The number of dispensing points depends upon the relative use of the product, the size of the vending system, and other factors. Thus, while two dispensing points are shown, it is to be realised that one or more dispensing points can be associated with the system. Further, multiple filling machines 12 can be included with the dispensing system 10. Consistent with the teaching of the description herein, one or more reservoirs 16a, 16b, 16c can be used to hold the concentrate and/or diluent sources and other additives described herein. The reservoirs can be coupled to the dispensing points 13a, 13b and controlled by one or more interfaces 20a, 20b.

Further, the dispensing system 10 can include one or more interfaces 20a, 20b to control the system sources, additives, and materials dispensed. In some embodiments, the interface 20a may be local to the dispensing system 10. In other instances, the interface can be a remote interface 20b that can be linked to the filling machine 12 in some manner known to those with ordinary skill in the art. The interfaces can be used to select and otherwise customise product dispensed through the dispensing prints A communicative device 22, such as a modem, link, or other communication devices, can be used to establish the link between the filling machine 12 and the interface 20b.

One or more containers 18a, 18b, can be used to hold the one or more dispensed product 14a, 14b. The dispensed product can be dispensed into the containers through one or more fill apertures 19a, 19b disposed on the containers.

While the foregoing is directed to various embodiments of the present invention, other and further embodiments may be devised without departing from the basic scope thereof. For example, the various methods and embodiments of the invention can be included in combination with each other to produce variations of the disclosed methods and embodiments. Also, the directions such as “top,” “bottom,” “left,” “right,” “upper,” “lower,” and other directions and orientations are described herein for clarity in reference to the figures and are not to be limiting of the actual device or system or use of the device or system. The device or system may be used in a number of directions and orientations. Further, the order of steps can occur in a variety of sequences unless otherwise specifically limited. The various steps described herein can be combined with other steps, interlineated with the stated steps, and/or split into multiple steps.

1. A process for the customisation of consumer products, which comprises the steps of:
(a) preparing said consumer products according to selections of product characteristics made by a consumer,
(b) optionally reconstituting with one or more other components, and
(c) dispensing from a vending system at a point-of-sale of said consumer products.

2. The process according to claim 1, wherein said process allows for the simultaneous multiple customisation, optional reconstitution with one or more other components and dispensing of consumer products.

3. The process according to claim 1, wherein the consumer product is dispensed into a reusable storage container.

4. The process according to claim 1, wherein the process includes a remote means of operating the vending system.

5. The process according to claim 2, wherein the process includes a remote means of operating the vending system.

6. A vending system for the customisation of consumer products, wherein said consumer products are prepared according to selections of product characteristics made by a consumer, optionally reconstituted with one or more other components and dispensed from said vending system at the point-of-sale of said consumer products.

7. The vending system according to claim 6, wherein said vending system allows for the simultaneous multiple customisation, optional reconstitution with one or more other components and dispensing of consumer products.

8. The vending system according to claim 6, wherein the vending system may be operated by a remote means.

9. The vending system according to claim 7, wherein the vending system may be operated by a remote means.

10. The vending system according to claim 8, wherein the remote means comprises a direct electronic link or a modem.

11. The vending system according to claim 6, wherein said vending system is connected to a plurality of interfaces and/or one or more further vending systems, such that any interface may be used to select and customise product according to availability of an interface and any dispense point may be used to dispense product according to loading.

12. The vending system according to claim 7, wherein said vending system is connected to a plurality of interfaces and/or one or more further vending systems, such that any interface may be used to select and customise product according to availability of an interface and any dispense point may be used to dispense product according to loading.

13. The vending system according to claim 8, wherein said vending system is connected to a plurality of interfaces and/or one or more further vending systems, such that any interface may be used to select and customise product according to availability of an interface and any dispense point may be used to dispense product according to loading.

14. The vending system according to claim 6, wherein said vending system may use a batch or a parallel process for handling product orders.

15. The vending system according to claim 7, wherein said vending system may use a batch or a parallel process for handling product orders.

16. The vending system according to claim 8, wherein said vending system may use a batch or a parallel process for handling product orders.

17. The vending system according to claim 10, wherein said vending system may use a batch or a parallel process for handling product orders.

18. The vending system according to claim 11, wherein said vending system may use a batch or a parallel process for handling product orders.
